(19) United States
(12) Patent Application Publication
(10) Pub. No.: US 2013/0161244 A1
(43) Pub. Date: Jun. 27, 2013

(54) Chromatography Device

(71) Applicants: Kimihiko Ishii, Hitachinaka (JP); Mitsuhiko Ueda, Hitachinaka (JP); Shouji Tomida, Hitachinaka (JP)

(72) Inventors: Kimihiko Ishii, Hitachinaka (JP); Mitsuhiko Ueda, Hitachinaka (JP); Shouji Tomida, Hitachinaka (JP)

(73) Assignee: Hitachi High-Technologies Corporation, Minato-ku, Tokyo (JP)

(21) Appl. No.: 13/817,658

(22) PCT Filed: Jul. 21, 2011
(86) PCT No.: PCT/JP2011/066527

§ 371 Date: Feb. 19, 2013

(30) Foreign Application Priority Data
Sep. 17, 2010 (JP) 2010-208699

(51) Int. Cl. B01D 15/14

(52) U.S. Cl. CPC B01D 15/14
USPC 210/91; 210/143

(57) ABSTRACT

Provided is a highly safe chromatography device that does not sacrifice user-friendliness during the addition and replacement of a sample holding container. The chromatography device has doors 10, 11, a door locking mechanism 15, and a sensor 13 for detecting whether the doors 10, 11 are open or closed. The doors 10, 11 are opened and closed to place a sample holding container 6 and a sample rack 1 in the chromatography device. The door locking mechanism 15 is operated to lock the doors 10, 11 when the sensor 13 indicates that the doors 10, 11 are closed and the analysis of a sample in the sample holding container 6 starts, and is operated to unlock the doors 10, 11 when a return operation and a washing operation terminate after a needle 2, a syringe 9, and other mechanical parts operate. Consequently, the sample holding container can be safely added or replaced without having to perform, for instance, a procedure for executing a pause function.

### TECHNICAL FIELD

The present invention relates to a chromatography device, and more particularly to a chromatography device having a door for placing a sample holding container in the chromatography device.

### BACKGROUND ART

Well-known liquid chromatography devices and gas chromatography devices are configured so that each device is functionally divided into blocks. The blocks are housed in respective housings. The housings are vertically stacked.

A liquid chromatography device described, for instance, in Patent Literature 1 is configured so that various functions are separately implemented in a liquid supply pump unit, an automatic sampler unit, a column oven unit, and a detector unit. Another chromatography device described, for instance, in Patent Literature 2 is configured so that various functions are separately implemented in a pump device, a sample supply device, a column oven device, and a detection device. A gas chromatography device described, for instance, in Patent Literature 3 includes a carrier gas container section, a column section, a column temperature rise section, a sample gas injection section, and a data display section, which are housed in respective housings. The housings are stacked with their outer surfaces formed into the same shape.

Some of the chromatography devices described above include an automatic sample introduction device (automatic sampler unit, sample supply device, and sample gas injection section) that uses a needle to suction a sample liquid from sample holding containers (sample bottles) disposed in a sample rack attached to a rack holder and automatically injects the sample liquid into a chromatography mobile phase (carrier). In some cases, the sample rack placed in the automatic sample introduction device is detachable from the automatic sample introduction device. When such a structure is employed, the sample rack can be removed from the automatic sample introduction device and taken to a different place. Hence, the sample holding containers can be mounted on or dismounted from the sample rack at such a different place. This provides increased user-friendliness. If the sample holding containers are mounted on a plurality of sample racks beforehand, the sample liquid can be changed promptly.

The front surface of the automatic sample introduction device for the chromatography devices described in Patent Literatures 1 and 2 is equipped with a door that can be opened and closed by a user. When adding or replacing a sample holding container for analysis (or a sample rack on which sample holding containers are mounted) or when performing maintenance on a chromatography device, the user manually opens and closes the door. The door is installed in order, for instance, to obtain highly reproducible analysis results by reducing temperature changes in the chromatography device (temperature changes in the sample liquid) that may be caused by environmental temperature changes, prevent extraneous dust from entering the chromatography device, and assure increased safety by decreasing the risk of the user inadvertently coming into contact with a movable part of the automatic sample introduction device during an analysis.

When the user uses the above-described conventional sample introduction device and opens the door to perform the above-mentioned task during an injection operation, device handling instructions, warnings, and other precautionary concerns are mainly used to reduce the risk of the user inadvertently coming into contact with a moving needle or a sample measurement section and becoming injured. In other words, the reduction of hazard potential largely depends on the hazard awareness of the user.

Meanwhile, the technological background for chromatography devices indicates that there is and will be a continuing demand for increasing the throughput of a chromatography device. Because of a recent increasing need for analysis time reduction and of the advent of a high-speed analysis column thanks to advanced filler technologies, it is demanded that the automatic sample introduction device have enhanced sample processing capabilities. Therefore, the movable parts (needle, sample measurement section, etc.) of a sample introduction device are improved to exhibit a higher speed and perform parallel operations. This will further increase the risk of the user coming into contact with high-speed movable parts of the automatic sample introduction device during an analysis.

In view of the above circumstances, most of recent automatic sample introduction devices have a pause mode for allowing the user to safely add or replace a sample holding container (or a sample rack on which sample holding containers are disposed). For example, if the user enters the pause mode of such a sample introduction device during a sample processing sequence, the chromatography device checks injection tasks such as a needle transfer and a sample measurement section operation, waits until minimum required tasks are completed, and switches to a standby state. In the standby state, the user can safely add or replace a sample holding container (or a sample rack) because the movable parts of the chromatography device are halted.

When the user performs a procedure for exiting the pause mode after the addition or replacement of a sample holding container (or a sample rack), the chromatography device switches from the standby state to an operating state and resumes the sample processing sequence at the point of interruption. After completing the remaining portion of the sample processing sequence, the chromatography device reverts to the standby state. As described above, using the pause mode incorporated in the chromatography device reduces the risk of the user inadvertently coming into contact with a moving part in the chromatography device.

### CITATION LIST

### Patent Literature

Patent literature 1: Japanese Patent No. 4348025
Patent literature 2: Japanese Patent No. 3029365
Patent literature 3: Japanese Utility Model Laid-open No. Sho 61 (1986)-189264

### SUMMARY OF INVENTION

### Technical Problem

However, it should be noted that the above-described pause mode sacrifices user-friendliness although it provides increased safety assurance when a sample holding container (or a sample rack) is added or replaced.

The pause mode is generally activated by performing the following steps. First of all, the user performs an input procedure for entering the pause mode with respect to the chromatography device. Upon receipt of a pause request from the user, the device performs a process necessary for switching to a state where the device can pause (hereinafter referred to as the standby state), and displays a wait message on the screen (not shown) of the device to indicate that the device is switching to the standby state. The reason is that if, for instance, the device is permitted to come to a sudden stop at an arbitrary timing at which a sample is being introduced, sample analysis data may not be acquired while part of the sample remains in an introduction flow path, which results in the waste of a precious sample. Hence, the user has to wait until the device switches to the standby state and cannot add or replace a sample holding container (or a sample rack) before the device is placed in the standby state.

When the device has completely switched to the standby state, the device illuminates its LED (not shown) or displays a message on its display screen (not shown) in order to notify the user that it has switched to the standby state. The user confirms the above notification to determine whether a sample holding container (or a sample rack) can be added or replaced, and then proceeds to add or replace the sample holding container (or the sample rack).

After adding or replacing the sample holding container (or the sample rack), the user performs an input procedure for exiting the pause mode. The reason is that the device cannot determine whether or not to resume the sample processing sequence at the point of interruption until it receives a signal indicative of the completion of the user's addition or replacement.

A predetermined timeout period for addition/replacement may be adopted in order to save the user the trouble of performing the input procedure for exiting the pause mode. However, if the addition or replacement is completed immediately, the timeout period turns out to be the loss of device operating time. If, on the contrary, the timeout period is too short, the device starts operating before the user completes the addition or replacement, thereby creating an increased safety hazard for the user.

As such being the case, even if the device has the pause mode, the user cannot leave the device until the user completes a procedure for entering or exiting the pause mode. Therefore, the user feels bothered. Particularly, the time required for the device to switch into the standby state after the user performs a procedure for entering the pause mode ranges from several seconds to several minutes. During such a period, the user has to pay attention to the device. In this case, it is obvious that the device is not an easy-to-use chromatography device.

The present invention has been made in view of the above circumstances. An object of the present invention is to provide a chromatography device that is user-friendly and safe to use.

### Solution to Problem

In accomplishing the above object, according to an aspect of the present invention, there is provided a chromatography device having a door, a lock means for locking the door, and a door open/close detection means for detecting whether the door is open or closed, the door being opened and closed in order to place a sample holding container in the chromatography device. The chromatography device includes a control section that switches at least between a standby state and an analysis state and controls the locking of the door in accordance with information indicative of a mechanism operation period in the chromatography device during the analysis state and with a door open/close signal supplied from the door open/close detection means. Hence, the locking of the door is controlled during the analysis state.

More specifically, the analysis state is divided into at least an injection period for a sample, a return period, a washing period, and a data acquisition period, whereas the mechanism operation period includes the injection period, the return period, and the washing period. This shortens the period during which the door is locked. Further, the door is locked if it is closed at the beginning of an analysis. Furthermore, the door is unlocked upon termination of the return period and the washing period. This provides safety assurance without disturbing a user's operation. These and other features will become more apparent from the following description of embodiments.

The mechanism operation period is a period during which a needle, a cylinder, and other movable mechanisms operate, for instance, for sample injection purposes. The detailed structures of the movable mechanisms vary from one chromatography device to another.

### Advantageous Effects of Invention

According to the present invention, the locking of the door is controlled in accordance with the information indicative of the mechanism operation period and with the door open/close signal. Therefore, for example, the addition or replacement of a sample holding container can be safely carried out without having to perform a procedure, for instance, for entering the pause mode. Thus, the present invention provides a chromatography device that excels in safety and user-friendliness.

### BRIEF DESCRIPTION OF DRAWINGS

FIG. 1 is a block diagram illustrating a liquid chromatography device according to one embodiment of the present invention.

FIG. 2 is a block diagram illustrating the liquid chromatography device according to another embodiment of the present invention.

FIG. 3 is a general view of a sample introduction device according to one embodiment of the present invention.

FIG. 4 is a general view illustrating a door-open state of the sample introduction device shown in FIG. 3.

FIG. 5 is a diagram illustrating the configuration of a sample holding container according to one embodiment of the present invention.

FIG. 6A is a general view illustrating an unlocked state of a door locking mechanism according to one embodiment of the present invention.

FIG. 6B is a general view illustrating how the door locking mechanism shown in FIG. 6A looks when it is uncovered.

FIG. 6C is an enlarged general view of the door locking mechanism shown in FIG. 6B.

FIG. 7A is a general view illustrating a locked state of the door locking mechanism according to one embodiment of the present invention.

FIG. 7B is an enlarged general view of the door locking mechanism shown in FIG. 7A.

FIG. 8 is a state transition diagram illustrating the automatic sample introduction device according to one embodiment of the present invention.

FIG. 9 is a timing diagram illustrating an analysis state according to one embodiment of the present invention.

FIG. 10 is a flowchart illustrating the analysis state according to one embodiment of the present invention.

FIG. 11 is a state transition diagram illustrating the automatic sample introduction device according to another embodiment of the present invention.

### DESCRIPTION OF EMBODIMENTS

Embodiments of the present invention will now be described with reference to the accompanying drawings. In the following description it is assumed that a liquid chromatography device is used as a chromatography device and that the chromatography device is functionally divided into blocks housed in respective housings. However, it is obvious that the present invention is applicable to a door for placing a sample holding container in the chromatography device even when a gas chromatography device is employed or when the chromatography device is housed in one or more housings.

### [Configuration of Liquid Chromatography Device]

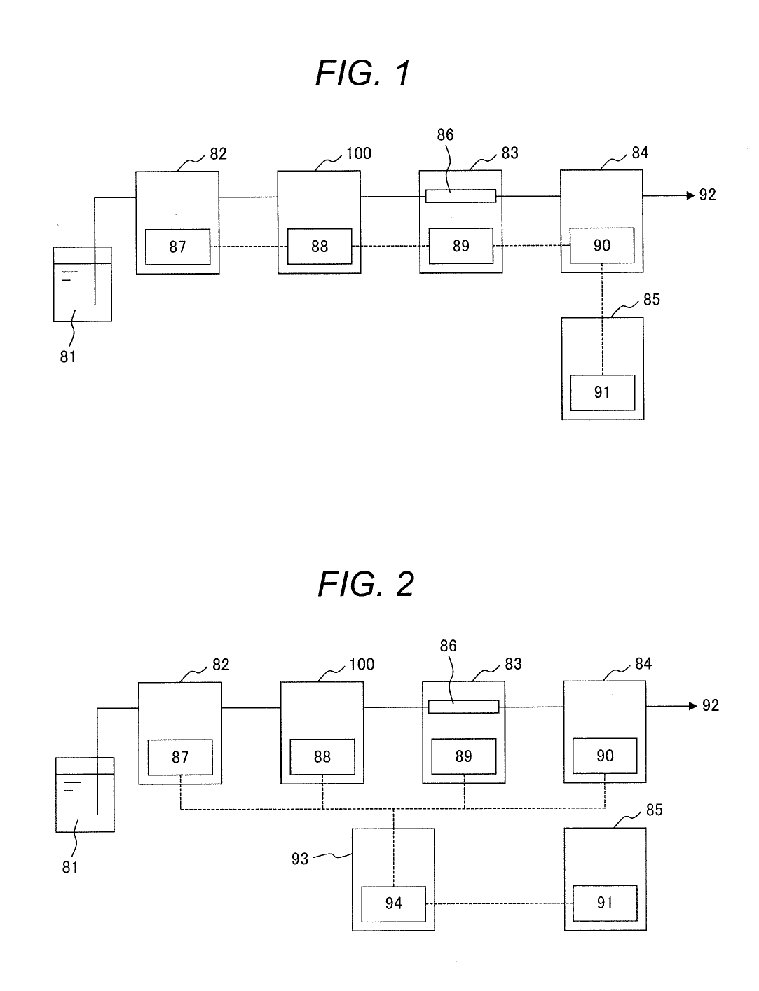

FIG. 1 is a block diagram illustrating a liquid chromatography device according to one embodiment of the present invention. A mobile phase 81 is supplied by a liquid supply device 82. A sample is introduced into an analysis flow path by a sample introduction device 100, separated by a column 86 in a column thermostatic tank 83, forwarded to a detector 84, and discharged into a drain 92. A data processing device 85 receives a signal of the detector 84, performs data processing, and outputs the results of qualitative/quantitative analysis of components. The liquid supply device 82, the sample introduction device 100, the column thermostatic tank 83, the detector 84, and the data processing device 85 each incorporate a control section 87-91.

FIG. 2 is a block diagram illustrating the liquid chromatography device according to another embodiment of the present invention. The liquid chromatography device shown in FIG. 2 differs from the liquid chromatography device shown in FIG. 1 in that a system control section 94 in a system controller 93 provides centralized control of the liquid supply device 82, the sample introduction device 100, the column thermostatic tank 83, and the detector 84. The data processing device 85 receives a signal of the detector 84 through the system controller 93, performs data processing, and outputs the results of qualitative/quantitative analysis of components.

### [Automatic Sample Introduction Device]

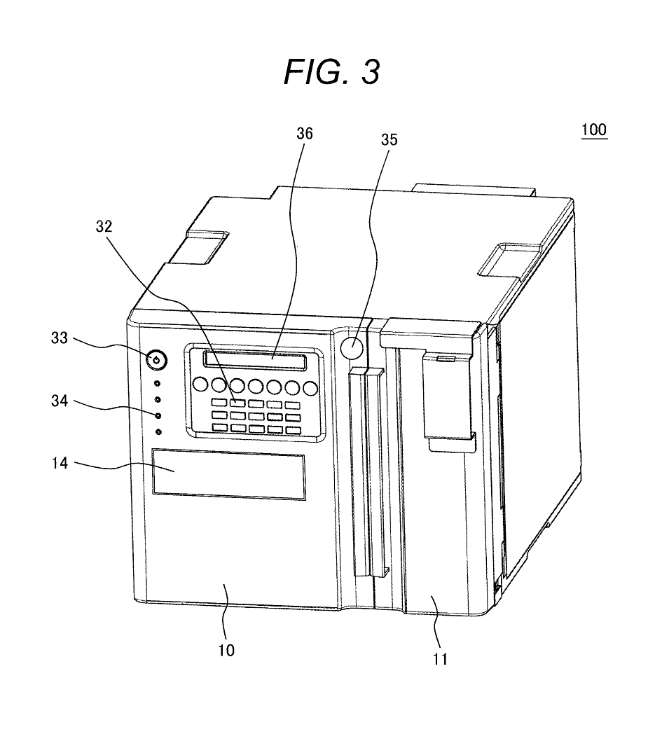

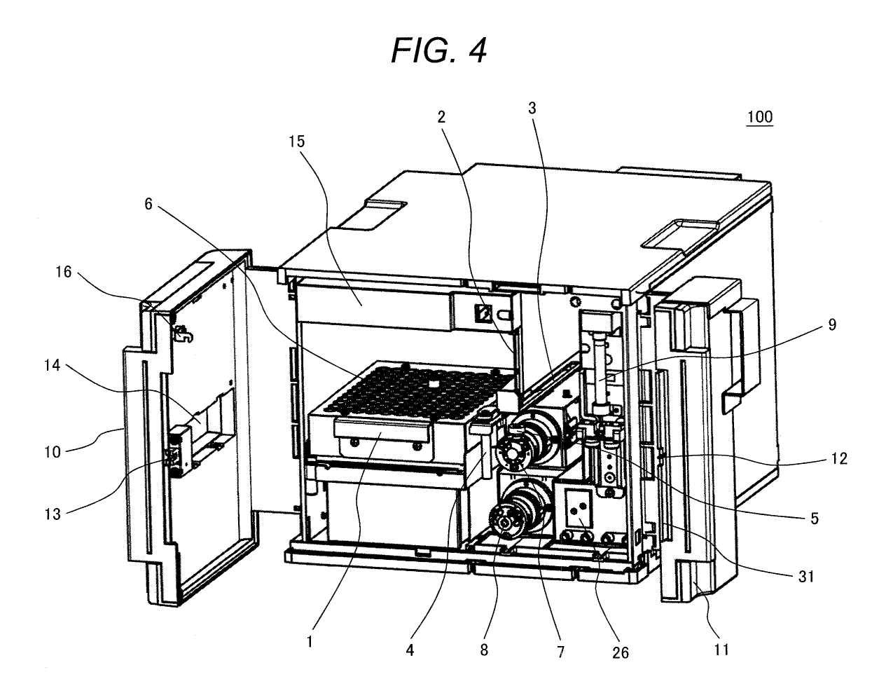

FIGS. 3 and 4 are general views of the automatic sample introduction device 100, which is a part of the liquid chromatography device. Hinged double doors (left door 10 and right door 11) are provided on the front of the automatic sample introduction device 100. FIG. 3 shows a state where the left door 10 and right door 11 on the front of the automatic sample introduction device 100 are closed. FIG. 4 shows a state where the left door 10 and right door 11 on the front of the automatic sample introduction device 100 are open.

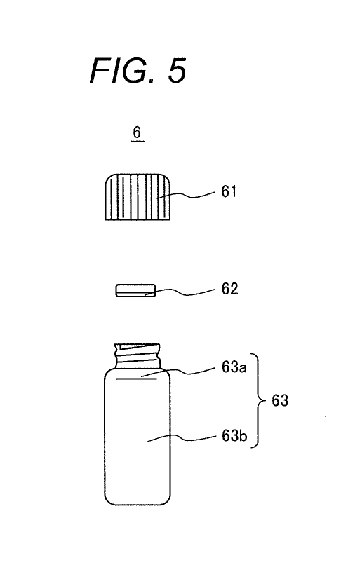

A sample holding container 6 (see FIG. 5) including a sample liquid is mounted on a sample rack 1. The sample rack 1 is detachable from the automatic sample introduction device 100 and placed in the automatic sample introduction device 100 during an analysis. An arm 3 moves a needle 2 in three axial directions, namely, in a left-right direction (X), in a front-rear direction (Y), and in an up-down direction (Z). Thus, the needle 2 freely moves between the sample holding container 6, a washing tank 4, and a sample injection port 5 (positioned on a flow path changeover valve 7). The needle 2 is connected to a flow path changeover valve 8 through a piping (not shown) and is further connected to a syringe 9, which is a sample measurement section, through a piping (not shown).

At the beginning of an analysis, the needle 2 is cleaned in the washing tank 4 and inserted into the sample holding container 6. The syringe 9 is then driven so that the leading end of the needle suctions the sample to be measured. After the sample is suctioned, the needle 2 is inserted into the sample injection port 5. The syringe 9 is then driven to introduce the sample into the piping of a sample loop (not shown) connected to the flow path changeover valve 7. Subsequently, the flow path changeover valve 7 changes its position to introduce the sample into the analysis flow path. A control circuit board and power supply (not shown) for driving the needle 2, the syringe 9, and the flow path changeover valves 7, 8 are mounted in the automatic sample introduction device 100.

The left door 10 and right door 11 of the automatic sample introduction device 100 are structurally designed so that they are opened and closed in the following steps.

(a) The doors are to be opened by first opening the left door 10 and then opening the right door 11.
(b) The doors are to be closed by first closing the right door 10 and then closing the left door 10.

If, for instance, an attempt is made to first close the left door 10 and then close the right door 11, a protrusion 31 on the right door 11 collides against the left door 10 so that the right door 11 does not properly close. When both the left door 10 and the right door 11 are properly closed, a detection plate 12 on the left door 10 and a door open/close sensor 13 on the right door 11 work to detect that the doors are closed. Further, a door locking mechanism 15 is disposed on the front of the device. While the left door 10 and the right door 11 are properly closed, the doors 10, 11 can be locked with a claw 16 caught by the door locking mechanism 15.

When a user is to place the sample holding container 6 (or the sample rack 1 on which the sample holding container 6 is mounted) in the device, the user merely has to open and close the left door 10 and does not have to open or close the right door 11. When, on the other hand, the user is to perform maintenance, for instance, on the washing tank 4, the sample injection port 5, the flow path changeover valves 7, 8, or the syringe 9, the user has to open the right door 11.

Further, the left door 10 is provided with a window 14 that permits the user to visually check the inside of the device. Therefore, even when the left door 10 is closed, the user can visually check (a) whether the needle 2 is operating and (b) whether the needle 2 is properly inserted into the sample holding container 6 that is placed in its position.

FIG. 5 is a diagram illustrating the configuration of the sample holding container 6 mounted on the sample rack 1. The sample holding container 6 shown in FIG. 5 is substantially shaped like a cylinder and provided with a cap 61, a septum 62, and a sample bottle 63. The sample bottle 63 is formed by a barrel 63a and a neck 63b. The barrel 63a is substantially shaped like a cylinder. The neck 63b is smaller in diameter than the barrel 63a and provided with an opening. The sample liquid to be measured is placed in the sample bottle 63. The opening of the sample bottle 63 is sealed with the cap 63 through the septum 62.

### [Door Locking Mechanism]

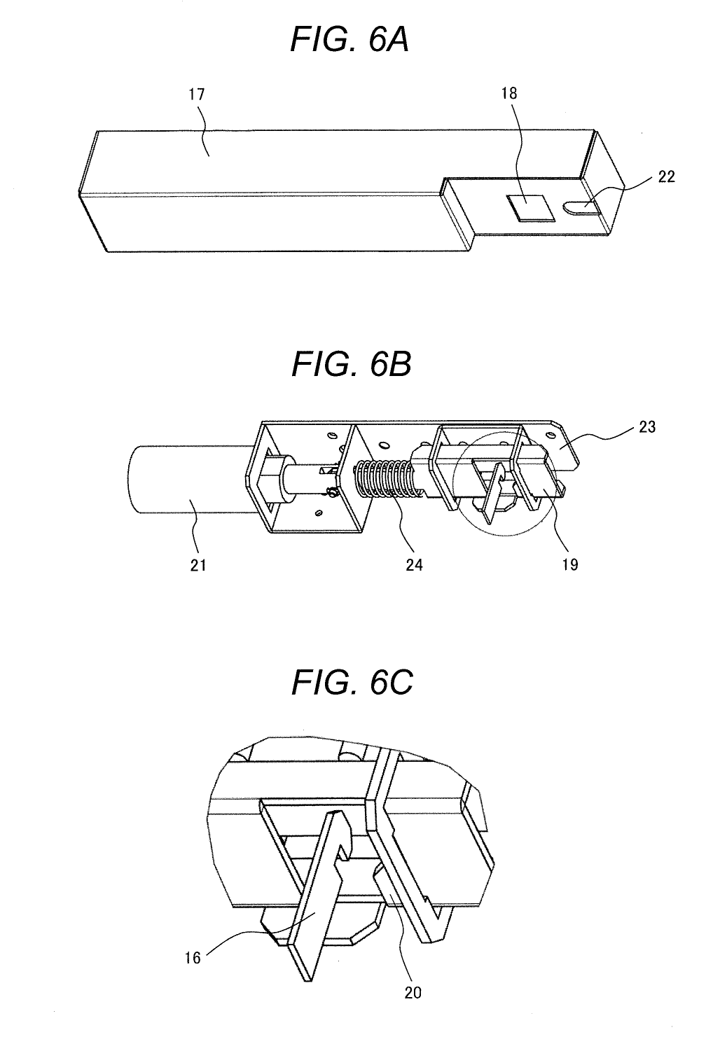

FIGS. 6A to 6C are configuration diagrams illustrating how the door locking mechanism 15 according to one embodiment of the present invention looks when it is unlocked. As shown in FIG. 6A, the door locking mechanism 15 includes a cover 17. The cover 17 has an opening 18. The claw 16 on the left door 10 can enter and leave the opening 18.

FIG. 6B is a configuration diagram illustrating how the door locking mechanism 15 looks when the cover 17 is removed from it. A solenoid 21 is coupled to a slide plate 19. The slide plate 19 can slide in a left-right direction. When no voltage is applied to the solenoid 21 (when the solenoid 21 is de-energized), a compression spring 24 causes the slide plate 19 to slide rightward and stop at the rightmost end.

FIG. 6C is an enlarged configuration diagram that relates to a state where no voltage is applied to the solenoid 21 (the solenoid 21 is de-energized) and shows the positional relationship between the claw 16 on the left door 10 and a notch 20 in the slide plate 19. The claw 16 can freely move in the direction of the depth of the device without interfering with the notch 20 at all. Therefore, while the right door 11 is closed, the left door 10 can be freely opened and closed.

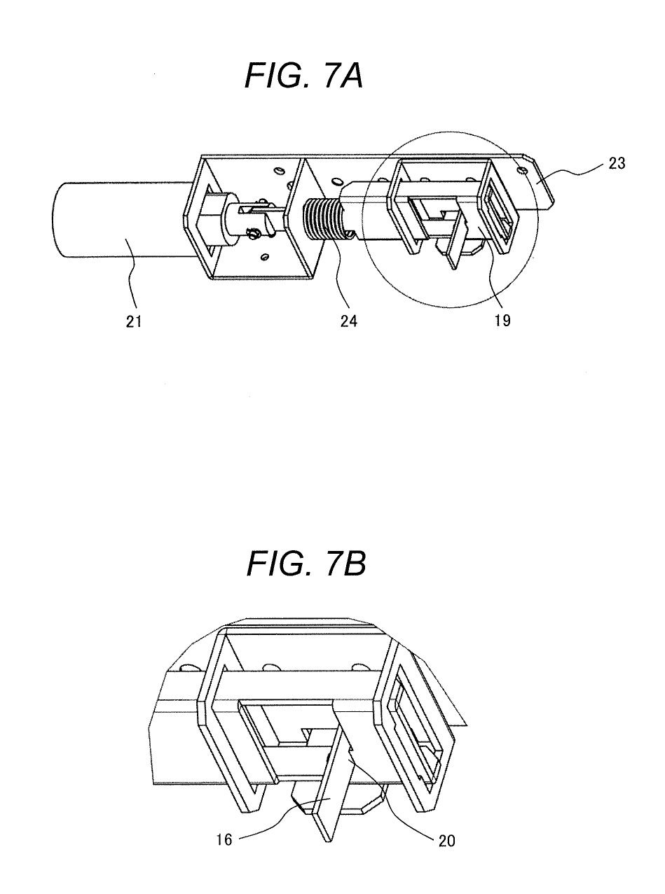

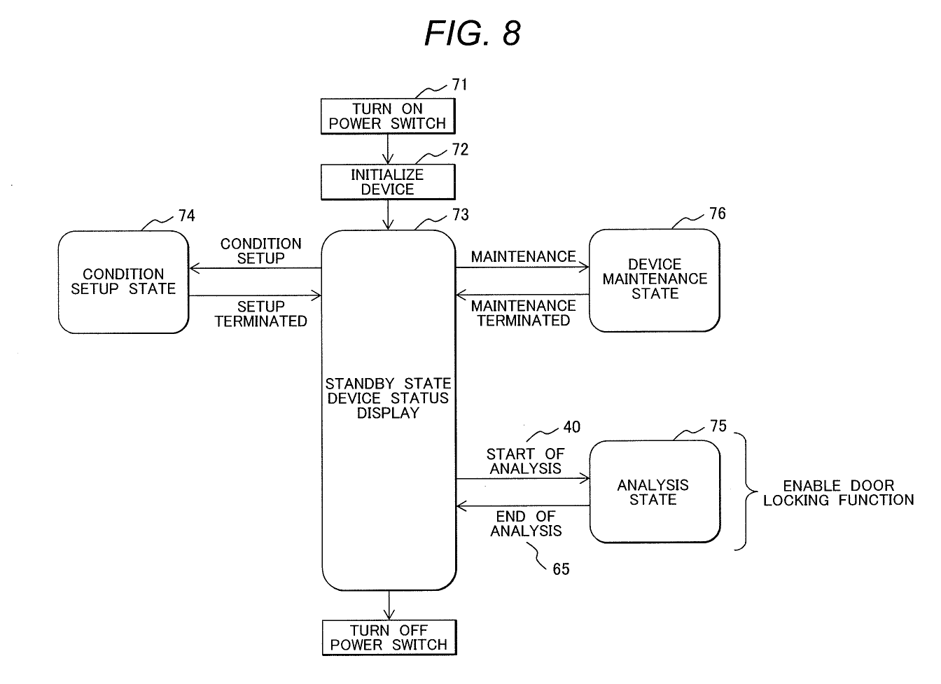

FIG. 7A is a configuration diagram illustrating how the door locking mechanism 15 according to one embodiment of the present invention looks when it is locked. If a voltage is applied to the solenoid 21 (the solenoid 21 is energized) while both doors are closed, electromagnetic force causes the slide plate 19 to slide leftward and stop at the leftmost end.

FIG. 7B is an enlarged configuration diagram that relates to the above state and shows the positional relationship between the claw 16 on the left door 10 and the notch 20 in the slide plate 19. While a voltage is applied to the solenoid 21 (the solenoid 21 is energized), the claw 16 is caught by the notch 20 in the slide plate and restrained from moving in the direction of the depth of the device. Therefore, even if the user attempts to open the left door 10, the user cannot open the left door 10. As the above-described configuration is employed, both doors can be locked.

In the present embodiment, the surface of the slide plate 19 is painted blue, whereas a cover surface 23 is painted red. Therefore, when the user looks into the device through an observation window 35 on the left door 10, an observation window 22 on the cover 17 makes the blue-colored surface of the slide plate 19 visible to the user when no voltage is applied to the solenoid 21 (the solenoid 21 is de-energized) and makes the red-colored cover surface 23 visible to the user when a voltage is applied to the solenoid 21 (the solenoid 21 is energized).

In other words, even when both doors are closed during an analysis, the user can visually recognize the surface color through the observation window 22 to determine whether the doors are locked. More specifically, (a) if the blue colored surface is visible, the user can find that both doors can be freely opened and closed (the doors are unlocked), and (b) if the red colored surface is visible, the user can find that both doors are locked and cannot be opened and closed. The above-described configuration can function as a mechanical indicator that can visually indicate whether the doors are locked. Alternatively, for example, an LED 34 or a display screen 31, which are mounted on the front of the sample introduction device 100, may be used to visually indicate to the user whether the doors are locked.

### [State Transition Diagram]

FIG. 8 is a state transition diagram illustrating the automatic sample introduction device according to one embodiment of the present invention.

When a power switch 33 turns on, an initialization process 72 for the device starts. Upon completion of the initialization process 72, the device switches to a standby state 73. In the standby state 73, a display screen 36 shows a status indicative of the current status of the device. If, for instance, a personal computer or other information terminal is used to control the automatic sample introduction device 100 according to the present invention, the screen (not shown) of the information terminal may display the status. This enables the user to grasp the current status of the device by noting the status displayed on the screen.

In the standby state 73, the user can switch to a condition setup state 74, an analysis state 75, or a device maintenance state 76 by operating an operation button 32 (or the information terminal). In the condition setup state 74, the user specifies the amount of sample injection and the sample holding container for analysis and sets various parameters such as the repetition count of analysis, the time of analysis, and the time of flow path washing. In the device maintenance state 76, for example, the user operates the device for parts replacement, views the operation record of the device, performs preliminary operations for analysis, and adjusts the positions of mechanical sections.

In the analysis state 75, the user actually analyzes the sample in accordance with the parameters set in the condition setup state 74. Upon completion of sample analysis, the device switches to the standby state 73. The control section 88 of the sample introduction device 100 includes a storage section (not shown) that stores information indicative of the standby state 73, the condition setup state 74, and the device maintenance state 76 as well as the parameters used in these states.

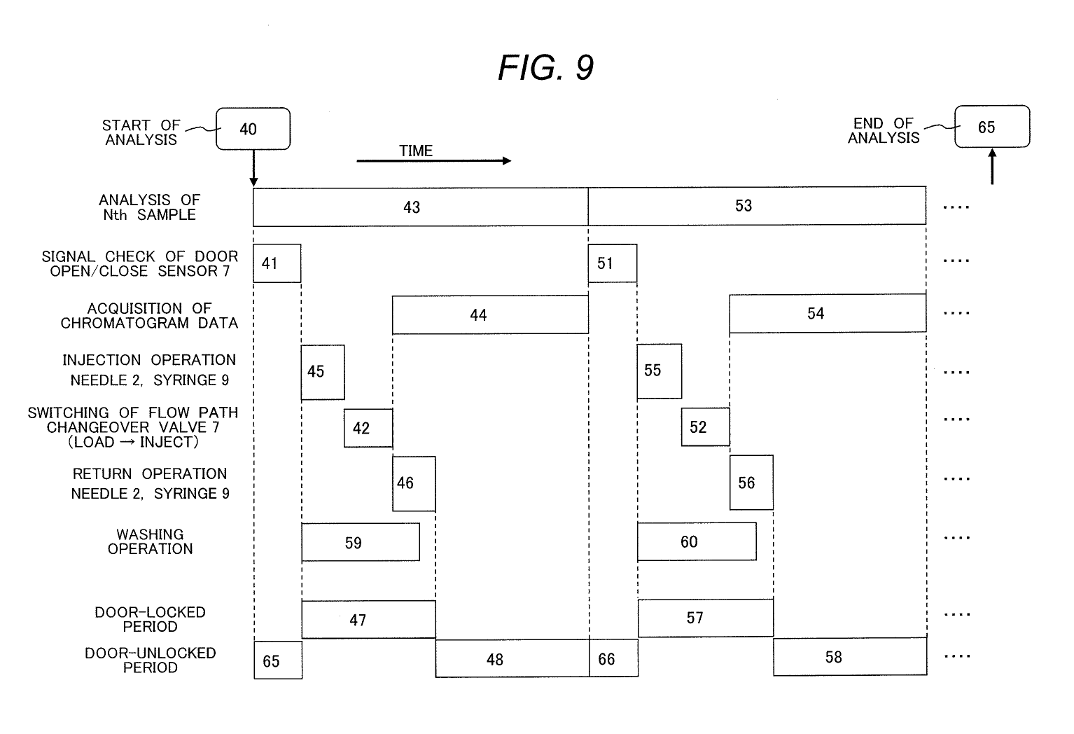

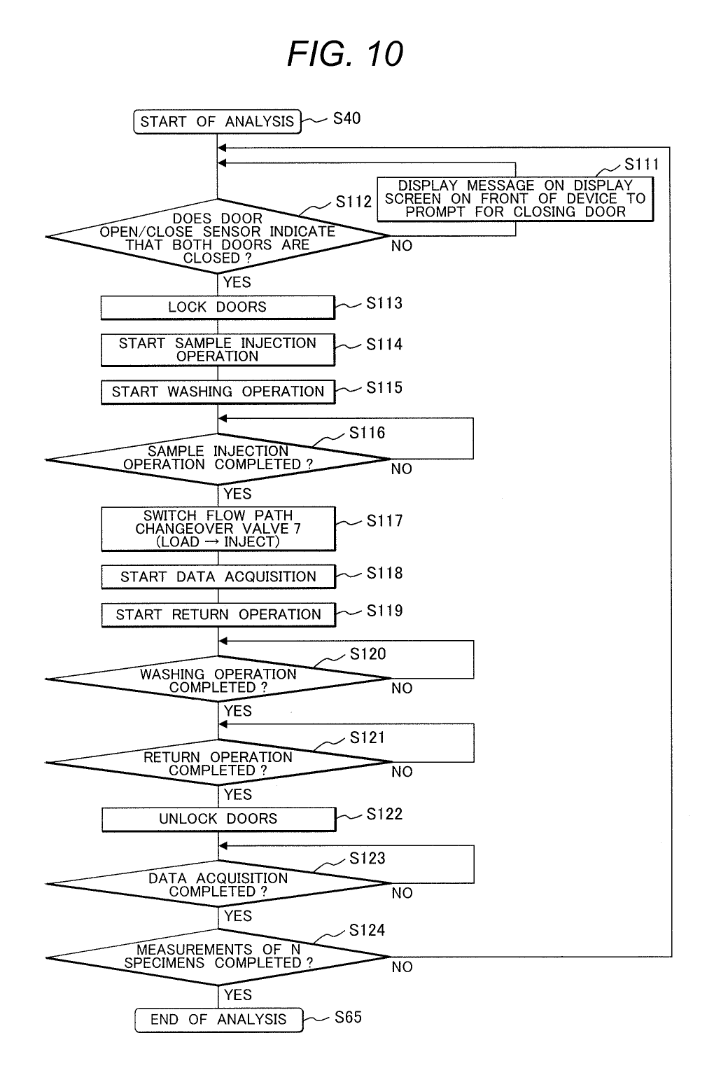

According to the present embodiment, a door locking function is enabled in the analysis state 75 and disabled in the other states. The door locking function will be described in detail below with reference to FIGS. 9 and 10.

### [Analysis State Timing Diagram]

FIG. 9 is a timing diagram illustrating the analysis state of the chromatography device that uses the automatic sample introduction device shown in FIG. 8, or more particularly, a timing diagram illustrating a continuous analysis of a polyspecimen.

When a command for an analysis start 40 is executed, a signal check 41 of the door open/close sensor 7 is initially performed to determine whether both doors are closed. If both doors are open, a message appears on the display screen 36 on the front of the device and on a screen (not shown) of a control information terminal to prompt the user to close the doors. In this instance, the device enters a wait state. The automatic sample introduction device 100 periodically monitors the signal of the door open/close sensor 7. When the automatic sample introduction device 100 verifies that both doors are closed, it applies a voltage to the solenoid 21 (energizes the solenoid 21) to lock both doors and initiates an injection operation 45.

The injection operation 45 is a series of operations performed to insert the needle 2 into the sample injection port 5 after the sample is suctioned, switches the flow path changeover valve 7 from the INJECT position to the LOAD position, and drive the syringe 9 to introduce the sample into the piping of the sample loop (not shown) connected to the flow path changeover valve 7.

Subsequently, the flow path changeover valve 7 is switched from the LOAD position to the INJECT position so as to introduce the sample into the analysis flow path and start the acquisition 44 of chromatogram data. After the data acquisition 44 is started, the automatic sample introduction device 100 performs a return operation 46. A washing pump 26 pumps a washing liquid (not shown) in parallel with the injection operation 45 and return operation 46 to clean the inner and outer walls of the needle 2, the washing tank 4, the flow path changeover valve 8, the piping (not shown), and other parts contaminated by the sample.

While the injection operation 45 or the return operation 46 is being performed, the needle 2 and the syringe 9 move at high speed. However, as the doors are locked by the door locking mechanism 15, it is possible to completely avoid the risk of the user inadvertently opening the doors for the purpose of adding or replacing the sample holding container 6 (or the sample rack 1 on which the sample holding container 6 is mounted) and coming into contact with a rapidly moving part.

Upon completion of the return operation 46, the device unlocks the doors. During a door-unlocked period 48 during which the doors are unlocked, the user can open and close the doors and add or replace the sample holding container 6 (or the sample rack 1 on which the sample holding container 6 is mounted).

Further, the user can view the observation window 35, the LED 34, and the display screen 36, which indicate whether the doors are locked and are shown in FIG. 3, and easily determine whether the sample holding container 6 (or the sample rack 1 on which the sample holding container 6 is mounted) can be replaced by opening the doors.

In general, in the analysis state, the total time required for the injection operation 45 and the return operation 46 is several tens of seconds, whereas the time required for the chromatogram data acquisition 44 ranges from several minutes to several tens of minutes. In other words, a door-locked period 47 per specimen during which the doors are locked is several tens of seconds, whereas the door-unlocked period 48 per specimen during which the doors are unlocked is sufficiently long as it ranges from several minutes to several tens of minutes. In reality, therefore, a time zone during which the sample holding container (or the sample rack on which the sample holding container is mounted) can be added or replaced is sufficiently longer than a time zone during which such addition or replacement cannot be made.

Consequently, the user can use the device without feeling undue stress. In addition, the user does not have to perform a procedure for entering and exiting a pause mode for addition/replacement, which needs to be performed when a conventional automatic sample introduction device is used. This saves the user the trouble of executing a pause function.

When the analysis 53 of a second specimen is to be started after the termination of the analysis 43 of a first specimen, a check 41 is performed again on the door open/close sensor 7 to determine whether the doors are closed. If the doors are open, a message appears on the display screen 36 on the front of the device and on the screen (not shown) of a device control information terminal to prompt the user to close the doors. In this instance, the device enters the wait state.

The automatic sample introduction device 100 periodically monitors the status of the door open/close sensor 7. When the automatic sample introduction device 100 verifies that both doors are closed, it applies a voltage to the solenoid 21 (energizes the solenoid 21) to start an injection operation 55. Subsequently, a continuous analysis is continued until the analysis of N specimens, which are similarly requested, is completed.

According to the present embodiment, the doors of the device are locked and cannot be opened by the user only during the injection and return periods in the analysis state (a period during which the user may inadvertently come into contact with a moving needle or syringe during an analysis). The doors are unlocked during the other periods. Consequently, a highly safe sample introduction device can be provided without sacrificing user-friendliness during the addition and replacement of the sample holding container (or the sample rack).

In the device maintenance state 76, the mechanism of the device may move while the user performs an operation (e.g., operates the device for parts replacement, performs preliminary operations for analysis, and adjusts the positions of mechanical sections). In this instance, however, the user consciously moves the movable parts of the device. Therefore, the risk of the user inadvertently coming into contact with a rapidly moving part is significantly lower than in the analysis state 75.

### [Analysis State Flowchart]

FIG. 10 is a flowchart illustrating the analysis state (the continuous analysis of a polyspecimen) according to one embodiment of the chromatography device that uses the automatic sample introduction device shown in FIG. 8.

When an analysis starts (step 40), the signal of the door open/close sensor 7 is initially checked to determine whether the doors are closed (step 112).

If both doors are open, a message appears on the display screen 36 on the front of the device and on the screen (not shown) of the control information terminal to prompt the user to close the doors (step 111). In this instance, the device enters the wait state. The automatic sample introduction device 100 periodically monitors the signal from of the door open/close sensor 7 (step 112). When the automatic sample introduction device 100 verifies that both doors are closed, it applies a voltage to the solenoid 21 (energizes the solenoid 21) to lock the doors (step 113) and start a sample injection operation (step 114).

The sample injection operation is a series of operations performed to insert the needle 2 into the sample injection port 5 after the sample is suctioned, switches the flow path changeover valve 7 from the INJECT position to the LOAD position, and drive the syringe 9 to introduce the sample into the piping of the sample loop (not shown) connected to the flow path changeover valve 7.

After the start of the sample injection operation, a washing operation begins (step 115). The washing operation is a series of operations in which the washing pump 26 pumps the washing liquid (not shown) to clean the inner and outer walls of the needle 2, the washing tank 4, the flow path changeover valve 8, the piping (not shown), and other parts contaminated by the sample.

Upon completion of the sample injection operation (step 116), the flow path changeover valve 7 switches from the LOAD position to the INJECT position (step 117) to introduce the sample into the analysis flow path and start the acquisition of chromatogram data (step 118). After the data acquisition is started, the automatic sample introduction device 100 begins to perform the return operation (step 119).

While the sample injection operation or the return operation is being performed, the needle 2 and the syringe 9 move at high speed. However, as the doors are locked by the door locking mechanism 15, it is possible to completely avoid the risk of the user inadvertently opening the doors for the purpose of adding or replacing the sample holding container 6 (or the sample rack 1 on which the sample holding container 6 is mounted) and coming into contact with a rapidly moving part.

After termination of the washing operation (step 120) and of the return operation (step 121), the device unlocks the doors (step 122). After the doors are unlocked, the user can open and close the doors and add or replace the sample holding container 6 (or the sample rack 1 on which the sample holding container 6 is mounted) even during data acquisition.

Further, the user can view the observation window 35, the LED 34, and the display screen 36, which indicate whether the doors are locked and are shown in FIG. 3, and easily determine whether the sample holding container 6 (or the sample rack 1 on which the sample holding container 6 is mounted) can be replaced by opening the doors.

In general, in the analysis state, the total time required for the injection operation and the return operation is several tens of seconds, whereas the time required for the chromatogram data acquisition ranges from several minutes to several tens of minutes. In other words, the door-locked period per specimen is several tens of seconds, whereas the door-unlocked period 48 per specimen is sufficiently long as it ranges from several minutes to several tens of minutes. In reality, therefore, a time zone during which the sample holding container 6 (or the sample rack 1 on which the sample holding container 6 is mounted) can be added or replaced is sufficiently longer than a time zone during which such addition or replacement cannot be made.

Consequently, the user can use the device without feeling undue stress. In addition, the user does not have to perform a procedure for entering and exiting the pause mode for addition/replacement, which needs to be performed when a conventional automatic sample introduction device is used. This saves the user the trouble of executing the pause function.

Upon completion of data acquisition (step 123), a check is performed to determine whether N specimens are completely measured as requested (step 124). If the measurements of N specimens are completed, the analysis terminates (step 65). If the analysis of N specimens is not completed, processing returns to step 112 to continue with the analysis of the remaining specimens.

As described above, the present embodiment makes it possible to provide a highly safe sample introduction device without sacrificing user-friendliness during the addition and replacement of the sample holding container (or the sample rack).

### [Second State Transition Diagram]

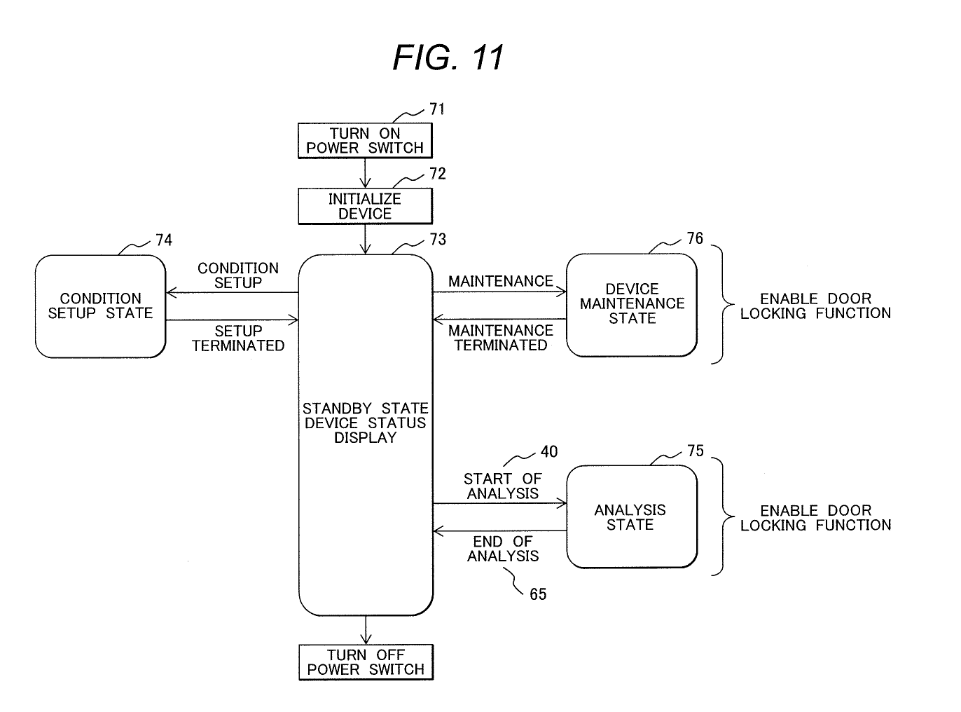

FIG. 11 is a state transition diagram illustrating the automatic sample introduction device according to another embodiment of the present invention. The diagram shown in FIG. 11 differs from the diagram shown in FIG. 8 in that the door locking function is enabled not only in the analysis state 75 but also in the device maintenance state 76. In other words, FIG. 11 depicts an example in which increased safety assurance is provided for the user while sacrificing user-friendliness to some extent.

### LIFT OF REFERENCE SIGNS

1 . . . Sample rack
2 . . . Needle
3 . . . Arm
4 . . . Washing tank
4 . . . Sample injection port
6 . . . Sample holding container
7 . . . Flow path changeover valve
8 . . . Flow path changeover valve
9 . . . Syringe
10 . . . Left door
11 . . . Right door
12 . . . Detection plate
13 . . . Door open/close sensor
14 . . . Window
15 . . . Door locking mechanism
16 . . . Claw
17 . . . Cover
18 . . . Opening
19 . . . Slide plate (blue)
20 . . . Notch
21 . . . Solenoid
22 . . . Observation window
23 . . . Cover surface (red)
24 . . . Compression spring
31 . . . Protrusion
32 . . . Operation button
33 . . . Power switch
34 . . . LED
35 . . . Observation window
36 . . . Display screen
40 . . . Start of analysis
43 . . . Analysis of first specimen
53 . . . Analysis of second specimen
65 . . . End of analysis
61 . . . Cap
62 . . . Septum
63a . . . Neck
63b . . . Barrel
81 . . . Mobile phase
82 . . . Liquid supply device
83 . . . Column thermostatic tank
84 . . . Detector
85 . . . Data processing device
86 . . . Column
87-91 . . . Control section
92 . . . Drain
93 . . . System controller
94 . . . System control section
100 . . . Sample introduction device

1. A chromatography device having a door, a lock means for locking the door, and a door open/close detection means for detecting whether the door is open or closed, the door being opened and closed in order to place a sample holding container in the chromatography device, the chromatography device comprising:
a control section that switches at least between a standby state and an analysis state and controls the locking of the door in accordance with information indicative of a mechanism operation period in the chromatography device during the analysis state and with a door open/close signal supplied from the door open/close detection means.

2. The chromatography device according to claim 1, wherein the analysis state includes at least an injection period for a sample, a return period, a washing period, and a data acquisition period; and wherein the mechanism operation period includes at least the injection period, the return period, and the washing period.

3. The chromatography device according to claim 2, wherein the control section locks the door when the door open/close signal supplied from the door open/close detection means at the beginning of analysis indicates that the door is closed, and unlocks the door upon termination of the return period and the washing period.

4. The chromatography device according to claim 3, further comprising:
a display means that prompts for closing the door if the door open/close signal supplied from the door open/close detection means at the beginning of analysis indicates that the door is open.

5. The chromatography device according to claim 1, wherein the door is for a sample introduction device in which the sample holding container is placed; and wherein the sample introduction device includes an operating mechanism having a needle and a cylinder.

6. The chromatography device according to claim 1, comprising:
a control section that switches between the standby state, the analysis state, and a device maintenance state and controls the locking of the door in accordance with the information indicative of the mechanism operation period in the chromatography device during the maintenance state and with the door open/close signal supplied from the door open/close detection means.
